(19) United States
(12) Patent Application Publication
(10) Pub. No.: US 2024/0013555 A1
(43) Pub. Date: Jan. 11, 2024

(54) IMAGE BASED REFERENCE POSITION IDENTIFICATION AND USE FOR CAMERA MONITORING SYSTEM

(71) Applicant: Stoneridge Electronics AB, Solna (SE)

(72) Inventors: Nguyen Phan, Allen Park, MI (US); Liang Ma, Rochester, MI (US); Utkarsh Sharma, Troy, MI (US); Troy Otis Cooprider, White Lake, MI (US)

(21) Appl. No.: 18/346,916

(22) Filed: Jul. 5, 2023

Related U.S. Application Data
(60) Provisional application No. 63/358,926, filed on Jul. 7, 2022.

(51) Int. Cl. G06V 20/56; G06T 3/40; G06T 7/13; G06V 10/24

(52) U.S. Cl. CPC G06V 20/588; G06T 3/40; G06T 7/13; G06V 10/245; G06T 2207/20132; G06T 2207/30256

(57) ABSTRACT

A method for determining an image reference position includes receiving at least one image from at least one camera at a controller, the image includes a road lane that is defined by two identifiable lane lines and the camera is a component of a camera monitoring system (CMS) for a vehicle. An inner edge of each lane line is identified in the two identified lane lines using image based analysis, and a vanishing point of the two identified lane lines is identified by extending the identified inner edges of each lane line to a point where the extended inner edges meet using the controller, and the vanishing point is provided to at least one CMS system as the image reference position.

### CROSS-REFERENCE TO RELATED APPLICATION

This application claims priority to U.S. Provisional Application No. 63/358,926 filed Jul. 7, 2022.

### TECHNICAL FIELD

This disclosure relates to image based detection of a reference point in an image feed from a camera in a camera monitoring system.

### BACKGROUND

Mirror replacement systems, and camera systems for supplementing mirror views, are utilized in commercial vehicles to enhance the ability of a vehicle operator to see a surrounding environment. Camera monitoring systems (CMS) utilize one or more cameras to provide an enhanced field of view to a vehicle operator. In some examples, the mirror replacement systems cover a larger field of view than a conventional mirror, or include views that are not fully obtainable via a conventional mirror.

During operation of the vehicle, certain CMS features rely on and utilize multiple aspects of the images generated by the CMS cameras for object detection, operation of direct CMS functions (e.g. mirror replacement displays), provision of data to other vehicle systems, and the like. Some of these systems and functions utilize features within the image, such as a trailer corner or a static marker located at a known height and position relative to the cameras in order to determine a reference position within the image.

Existing systems either assume that the camera is at a predefined “stock” position relative to the ground plane, with the stock position being determined at assembly or assume that the position is at a calibration position determined via a calibration performed while the truck is stationary. Based on these assumptions, the position of the image relative to the ground plane is assumed. Reliance on pre-existing calibrated reference positions can result in less accuracy when the camera position has changed since the default height was selected.

### SUMMARY

In one exemplary embodiment, a method for determining an image reference position includes receiving at least one image from a camera at a controller, the image includes a road lane that is defined by two identified lane lines and the camera is a component of a camera monitoring system (CMS) for a vehicle. An inner edge of each of the two identified lane lines is identified using image based analysis, and a vanishing point of the two identified lane lines is identified by extending the identified inner edges of each identified lane line to a point where the extended identified inner edges meet using the controller, and the vanishing point is provided to at least one CMS system as the image reference position.

In a further embodiment of any of the above, the at least one camera is at least one rear facing wing mounted camera.

In a further embodiment of any of the above, the identified inner edge of each identified lane line is an edge facing an inside of lane bounded by the two identified lane lines.

In a further embodiment of any of the above, the CMS system includes a real time camera height determination system, and the real time camera height determination system determines a height of the camera that is relative to a ground plane by determining an area of a triangle that is defined by the vanishing point and an edge of each identified lane line. The area of the triangle is converted into a corresponding camera height using the controller.

In a further embodiment of any of the above, converting the area of the triangle into a corresponding camera height using the controller includes identifying an entry that corresponds to the area of the triangle in a lookup table.

In a further embodiment of any of the above, the look up table includes a set of ranges of triangle areas, and each range of triangle areas in the set of ranges of triangle areas is correlated with a corresponding camera height.

In a further embodiment of any of the above, converting the area of the triangle into a corresponding camera height using the controller includes inputting the determined area of the triangle into an equation, and determining the camera height as an output of the equation.

In a further embodiment of any of the above, the method further includes comparing the identified vanishing point to a baseline vanishing point and determining that the identified vanishing point is accurate in response to the identified vanishing point being within a threshold distance of the baseline vanishing point.

In a further embodiment of any of the above, the method further includes verifying that a precondition is met prior to identifying the vanishing point of the two identifiable lane lines using the controller.

In a further embodiment of any of the above, the precondition is a speed of the vehicle that exceeds a first threshold, and yaw of the vehicle falls below a second threshold.

In a further embodiment of any of the above, the first threshold is at least 40 kilometers per hour, and the second threshold is at most 1 degree per second.

In a further embodiment of any of the above, receiving the at least one image from the at least one camera at a controller includes receiving a first image from a first camera and a second image from a second camera, and a first reference point is identified for the first image and a second reference point is identified for the second image. The CMS includes a display alignment system that is configured to align a first display of a first image and a second display of a second image by positioning the reference point of the first image and the reference point of the second image at identical vertical heights of corresponding display screens.

In a further embodiment of any of the above, positioning the reference point of the first image and the reference point of the second image at identical vertical heights of corresponding display screens includes aligning raw images at one of a top edge of the image and a bottom edge of the image, determining a vertical height difference between the corresponding reference points, and adjusting at least one of the first and second images such that the vertical height difference between the corresponding reference points is zero.

In a further embodiment of any of the above, adjusting the at least one of the first and second images includes cropping at least one of the first and second images and resizing at least one of the first and second images.

In another exemplary embodiment, a camera monitoring system (CMS) for a vehicle, the CMS includes a first and second rear facing camera, a controller that includes at least a processor and a memory, the memory storing instructions are configured to determine a real time camera height of at least one of the first and second rear facing cameras by identifying an inner edge of each lane line in two identified lane lines using image based analysis, and identifying a vanishing point of the two identified lane lines by extending the identified inner edges of each lane line to a point where the extended inner edges meet using the controller. The vanishing point provides to at least one CMS system as an image reference position.

In a further embodiment of any of the above, the at least one CMS system includes a real time height determination system, and the real time height determination system determines an area of a triangle that is defined by the vanishing point and an edge of each identifiable lane line and converts the area of the triangle into a corresponding camera height using the controller.

In a further embodiment of any of the above, converting the area of the triangle into a corresponding camera height using the controller includes identifying an entry that corresponds to the area of the triangle in a lookup table.

In a further embodiment of any of the above, the look up table includes a set of ranges of triangle areas, and each range of triangle areas in the set of ranges of triangle areas is correlated with a corresponding camera height.

In a further embodiment of any of the above, converting the area of the triangle into a corresponding camera height using the controller includes inputting the determined area of the triangle into an equation, and determining the camera height as an output of the equation.

In a further embodiment of any of the above, the CMS further includes comparing the identified vanishing point to a baseline vanishing point and determining that the identified vanishing point is accurate in response to the identified vanishing point being within a threshold distance of the baseline vanishing point.

In a further embodiment of any of the above, the at least one CMS system includes a display alignment system that is configured to align a first display of a first image and a second display of a second image by positioning the reference point of the first image and the reference point of the second image at identical vertical heights of corresponding display screens.

### BRIEF DESCRIPTION OF THE DRAWINGS

The disclosure can be further understood by reference to the following detailed description when considered in connection with the accompanying drawings wherein:

FIG. 1A is a schematic front view of a commercial truck with a camera monitoring system (CMS) used to provide at least Class II and Class IV views.

FIG. 1B is a schematic top elevational view of a commercial truck with a camera monitoring system providing Class II, Class IV, Class V and Class VI views.

FIG. 2 is a schematic top perspective view of a vehicle cabin including displays and interior cameras.

FIG. 3 is a flowchart illustrating a method for identifying a reference point within an image based on an image received from the camera.

FIG. 4 illustrates an exemplary raw image received from the camera for the method.

FIG. 5 illustrates a lane line edge based reference point detection performed on the raw image of FIG. 4.

FIG. 6 illustrates an alternate lane line edge based reference point detection performed on an alternate example raw image.

FIG. 7 illustrates an exemplary method for using the reference point of FIG. 3 to assist in generating a real time camera height determination.

FIG. 8 illustrates a geometric analysis of the detected vanishing point and the detected lane line edges of FIG. 5.

FIG. 9 illustrates an exemplary lookup table for use with the method of FIG. 3.

FIG. 10 illustrates an exemplary method for aligning CMS displays using the reference points identified in the method of FIG. 3.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

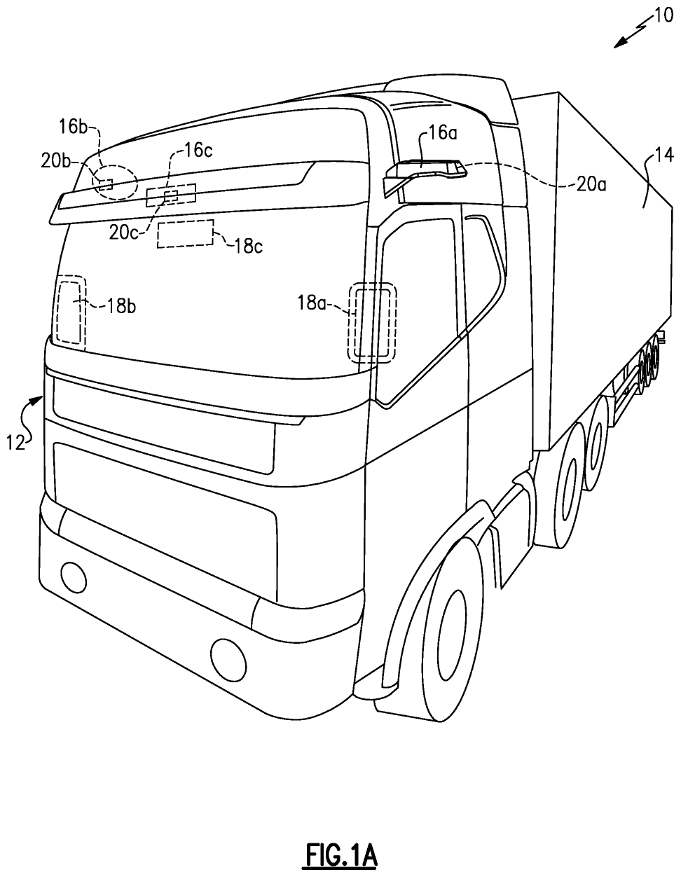

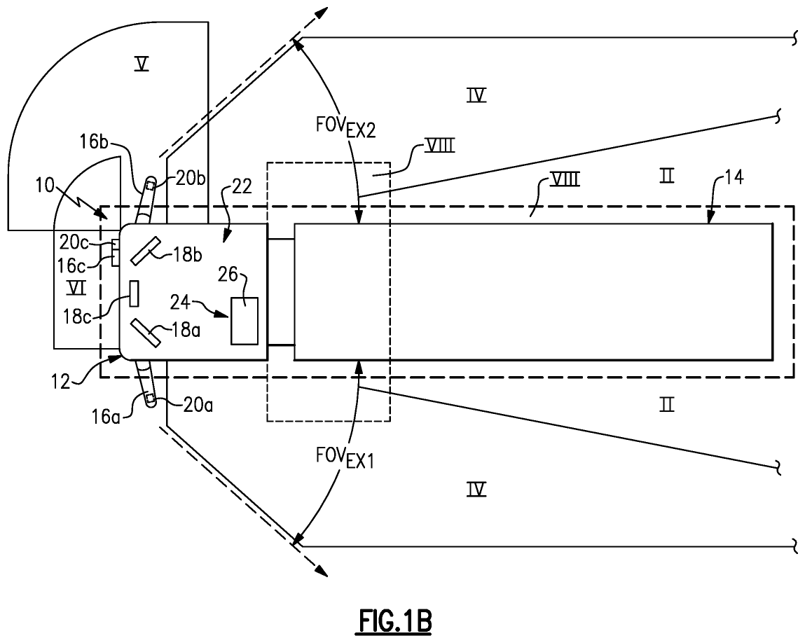

A schematic view of a commercial vehicle 10 is illustrated in FIGS. 1A and 1B. The vehicle 10 includes a vehicle cab or tractor 12 for pulling a trailer 14. It should be understood that the vehicle cab 12 and/or trailer 14 may be any configuration. Although a commercial truck is contemplated in this disclosure, the invention may also be applied to other types of vehicles. The vehicle 10 incorporates a camera monitoring system (CMS) 15 (FIG. 2) that has driver and passenger side camera arms 16a, 16b mounted to the outside of the vehicle cab 12. If desired, the camera arms 16a, 16b may include conventional mirrors integrated with them as well, although the CMS 15 can be used to entirely replace mirrors. In additional examples, each side can include multiple camera arms, each arm housing one or more cameras and/or mirrors.

Each of the camera arms 16a, 16b includes a base that is secured to, for example, the cab 12. A pivoting arm is supported by the base and may articulate relative thereto. At least one rearward facing camera 20a, 20b is arranged respectively within camera arms. The exterior cameras 20a, 20b respectively provide an exterior field of view FOV_{EX1}, FOV_{EX2} that each include at least one of the Class II and Class IV views (FIG. 1B), which are legal prescribed views in the commercial trucking industry. The Class II view on a given side of the vehicle 10 is a subset of the class IV view of the same side of the vehicle 10. Multiple cameras also may be used in each camera arm 16a, 16b to provide these views, if desired. Class II and Class IV views are defined in European R46 legislation, for example, and the United States and other countries have similar drive visibility requirements for commercial trucks. Any reference to a “Class” view is not intended to be limiting, but is intended as exemplary for the type of view provided to a display by a particular camera. Each arm 16a, 16b may also provide a housing that encloses electronics, e.g., a controller 30, that are configured to provide various features of the CMS 15.

First and second video displays 18a, 18b are arranged on each of the driver and passenger sides within the vehicle cab 12 on or near the A-pillars 19a, 19b to display Class II and Class IV views on its respective side of the vehicle 10, which provide rear facing side views along the vehicle 10 that are captured by the exterior cameras 20a, 20b. In some examples, the first and second video displays 18a, 18b operate as mirror replacement displays, while in other examples they can be operated as supplemental displays to physical mirrors.

If video of Class V and Class VI views are also desired, a camera housing 16c and camera 20c may be arranged at or near the front of the vehicle 10 to provide those views (FIG. 1B). A third display 18c arranged within the cab 12 near the top center of the windshield can be used to display the Class V and Class VI views, which are toward the front of the vehicle 10, to the driver.

If video of class VIII views is desired, camera housings can be disposed at the sides and rear of the vehicle 10 to provide fields of view including some or all of the class VIII zones of the vehicle 10. In such examples, the third display 18c can include one or more frames displaying the class VIII views. Alternatively, additional displays can be added near the first, second and third displays 18a, 18b, 18c and provide a display dedicated to providing a class VIII view. The displays 18a, 18b, 18c face a driver region 24 within the cabin 22 where an operator is seated on a driver seat 26. The location, size and field(s) of view streamed to any particular display may vary from the configurations described in this disclosure and still incorporate the disclosed invention.

The controller 30 is in communication with the cameras 20 and the displays 18. The controller 30 is configured to implement the various functionality disclosed in this application. The controller 30 may include one or more discrete units.

In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller 30 may be a hardware device for executing software, particularly software stored in memory. The controller 30 can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller 30 is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

Certain functions of the CMS 15, such as CMS display alignment and real time camera height determinations, rely on reference points within the images to provide accurate estimations, analysis, alignments, HMI placement. In existing systems, the reference points are either provided via placement of a marker or sticker at a known position on the trailer or via placement of reference marker at a known position relative to the camera while the vehicle is in a static position. The reference points provide accurate information of the image position relative to the ground plane that the vehicle is traveling on. This information is then used by one or more CMS systems.

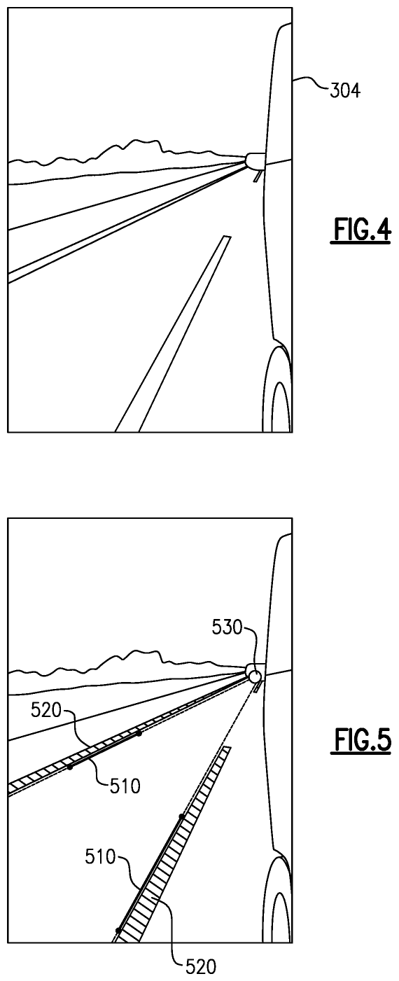

In order to provide currently accurate reference points within the images, the CMS incudes a method 300 for using image features and image analysis to identify a vanishing point reference position 530 within the images, or spaced outside of the images at a position extrapolated from the images. The method 300 is illustrated in FIG. 5 and is stored within a memory in the CMS or in communication with the controller 30. The method 300 is executed by the controller 30. In other examples, the method 300 can be stored and operated by other controller system(s) in communication with the controller 30. While illustrated and described at FIG. 5 with regards to a single image, it is appreciated that multiple images can simultaneously have the same process performed resulting in a determined reference position from each of the images.

Initially, the controller operating the CMS 15 receives a raw image 304 from the camera. Simultaneously, the controller receives a set of information 302 including odometery information. The odometry information includes at least a rate of change of position and yaw rate of the vehicle. When the set of information meets a predefined condition, the controller determines that the vehicle is traveling straight and at a speed above a required threshold such that the method 300 can proceed.

By way of example, when the yaw rate is less than about 1 degree per second, and the speed is greater than 40 Kilometers per hour, the preconditions indicate that the vehicle is traveling in a straight line, and the method 300 is capable of providing accurate real time reference position determinations. In another example, the speed threshold can be set at 50 kilometers per hour, or set within the range of 40 to 50 kilometers per hour. In other examples, other data received either directly or indirectly from a vehicle bus such as a CAN bus can be used to identify that a precondition corresponding to forward motion is met. Further, the described speed and yaw precondition is exemplary and is not limiting and other sets of preconditions can be utilized to similar effect.

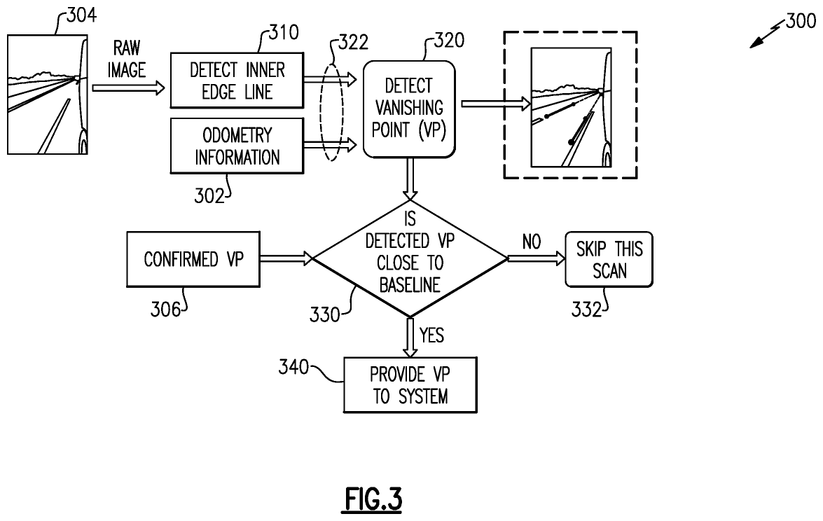

Once the preconditions are met, the method 300 analyzes the raw image (FIG. 4) using edge detection to detect line segments 510 at the inner edges of lane lines 520 in a “Detect Inner Edge Line” step 310. The inner edges of the lane lines 520 is the edge of the lane lines 520 nearest the inside of the lane defined by the lane lines. In alternative examples, alternative forms of object detection can be used to identify the positions of the lane lines 520, and the inner edges 510 can be detected accordingly.

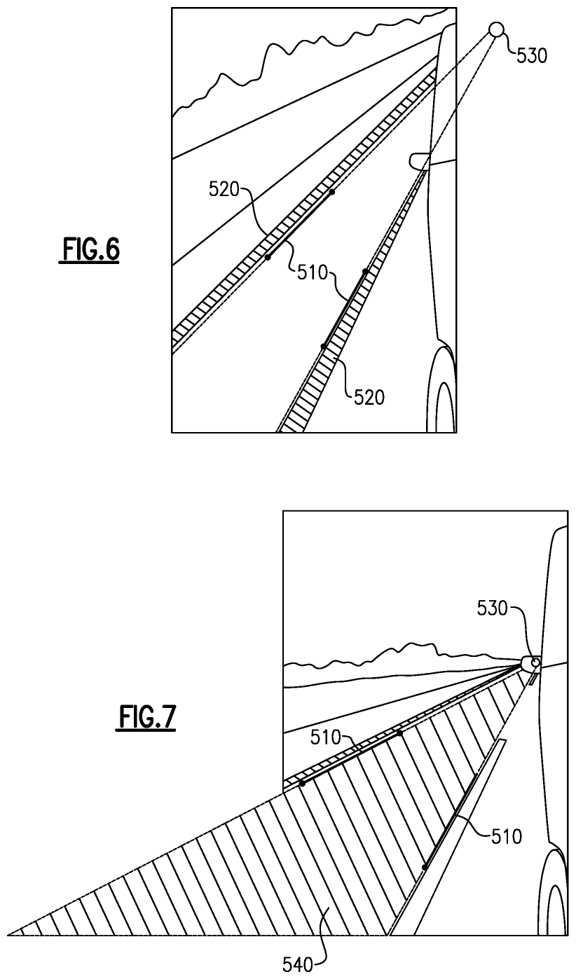

Once the line segments corresponding to the inner edges 510 of the lane lines 520 in the adjacent lane have been detected the inner edge lines 510 are extrapolated by the controller to a point in the image plane where they meet in a “Detect Vanishing Point” step 320. The vanishing point 530 is a single point in the plane of the image where two lane lines 520 that are parallel (or approximately parallel) in the real world meet. In the example image of FIG. 5, the vanishing point 530 is disposed within the image frame itself. In the alternative view illustrated in FIG. 6, the extrapolation of the inner edges 510 of the lane lines 520 extends outside of the image frame to a vanishing point 530. The controller 30 is able to track and calculate the vanishing point position 530 whether it is within the image frame (FIG. 5) or outside of the image frame (FIG. 6) and the method 300 described herein is equally functional in either example.

Once the vanishing point 320 has been detected, a baseline vanishing point 306 position is received from a stored memory in the CMS 15, and compared to the position in the image plane of the baseline vanishing point 306 and the detected vanishing point 530 in an “Is Detected Vanishing Point Close to the Baseline” step 330. The baseline vanishing point 306 is, in one example, the expected vanishing point based on a most recently calibrated camera height. In another example the baseline vanishing point is an aggregate (e.g., average) vanishing point position of the last several determinations.

In alternative examples, the baseline vanishing point 306 can be stored remote from the controller 30 and retrieved as necessary. The check performed at step 330 determines whether the vanishing point is within a predefined distance of the baseline vanishing point, and operates as a “sanity check”. When the detected vanishing point 530 is a number of pixels farther away from the baseline vanishing point 306 and the number of pixels is larger than the threshold, the controller 30 determines that the detected vanishing point is inaccurate, and the current camera height calibration is stopped in a “Skip this Scan” step 332.

When the determined vanishing point 530 is close enough to the baseline vanishing point, the CMS system identifies the determined vanishing point 530 as “reasonable” and provides the vanishing point to one or more CMS systems as a reference position (alternatively written as vanishing point reference position) in a “Provide VP To System” step 340.

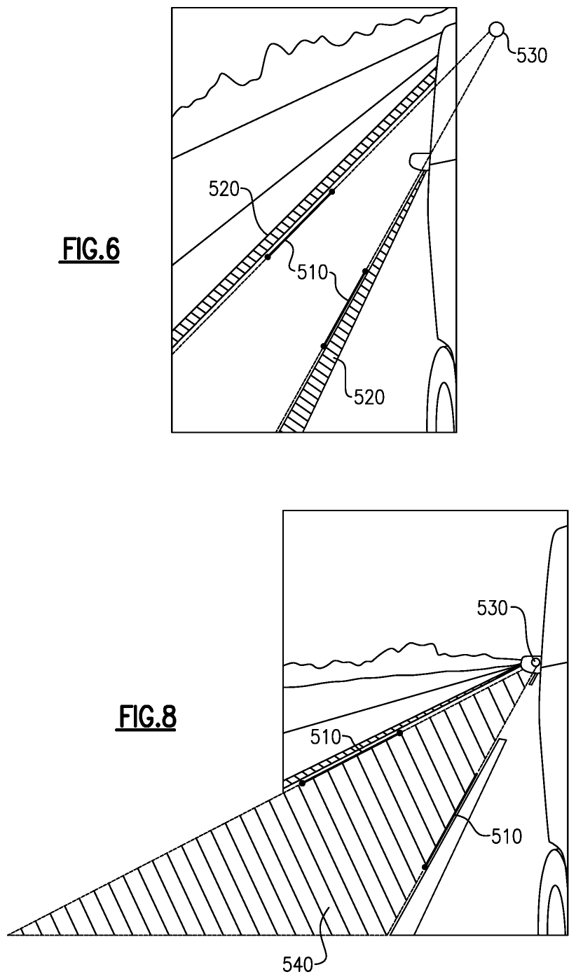

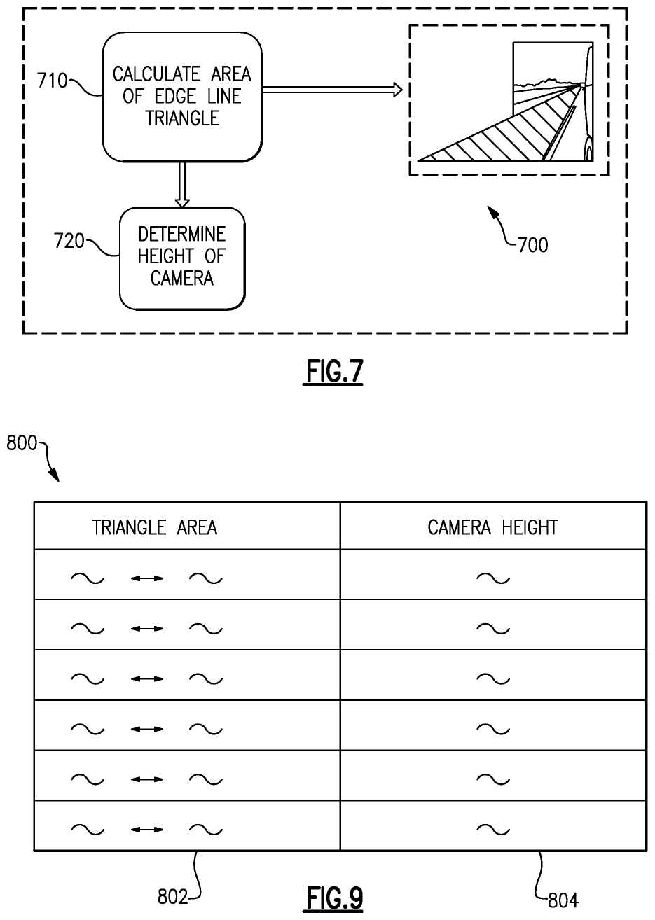

One system configured to receive and utilize the determined reference position is a real time camera height estimator 700. The process 700 for estimating the camera height initially defines a triangle 540 using the inner edge lines 510 and the vanishing point 530 (the determined reference position) in a “Calculate Area of Edge Line Triangle” step 340. The triangle 540 is defined in the image plane of the raw image 304 being analyzed, and is determined in pixels as the unit of measure. In alternative examples, alternative units of measurement can be used to the same effect. It is appreciated that the area of the triangle 540 is correlated with the height of the camera, relative to the ground. The area of the triangle is determined using any conventional image analysis or via geometric calculations according to known processes. FIG. 7 illustrates the example image of FIG. 5, with the addition of the determined triangle 540 defined in the image.

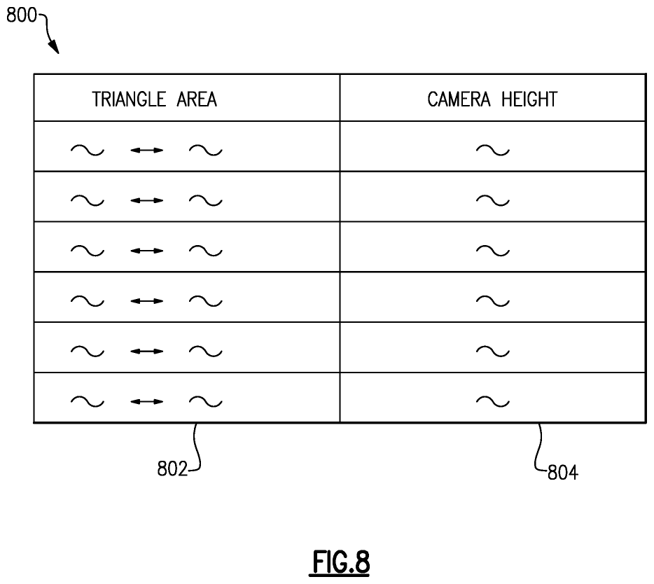

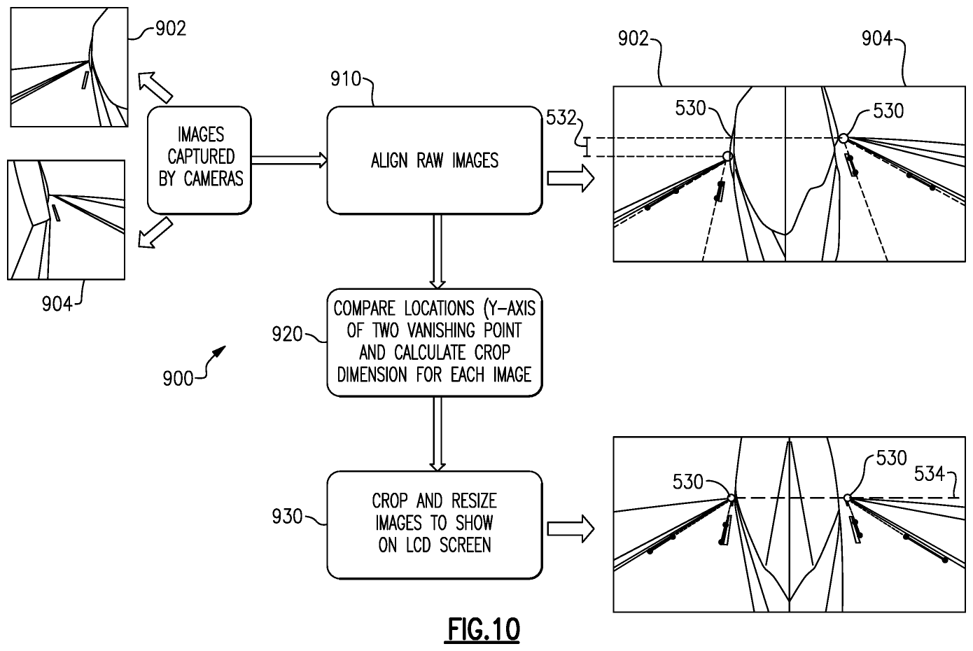

Once the area of the triangle 540 has been determined by the controller, the method 300 proceeds to determine the actual height of the camera originating the raw image 304 using the area of the triangle 540 in a “Determine Height of Camera” step 350. In one example, the height of the camera is determined by comparing the area of the triangle 540 to a lookup table 800 (illustrated in FIG. 9). The lookup table includes a set of ranges 802 of triangle areas 802, with each range 802 corresponding to a single camera height 804. In alternative examples, an equation can be utilized to determine the estimated height, with the equation relating the area of the triangle to the height of the camera based on internal testing.

The correlation between the area of the triangle 540 and the actual heights 804 is determined via testing on a particular vehicle configuration in laboratory testing, real world testing, or a combination of the two, with a substantial number of test results being used to verify the correlation. The usage of a range of triangle areas for each camera height allows the system to accommodate for minor variations that may occur due to imprecise lane spacing, minor inaccuracies in edge detection, and similar variations that can occur due to the natural conditions of a real world road system.

After having determined the height of the camera, the CMS stores the new camera height and provides the new camera height to any active systems that utilize camera height, or where a change in camera height would impact the operation of the system.

The real time camera height determination can be iterated every time the precondition is met, once per engine cycle, each time the precondition returns to being met, or at any other frequency that ensure continuous up to date camera height information is provided to the controller 30.

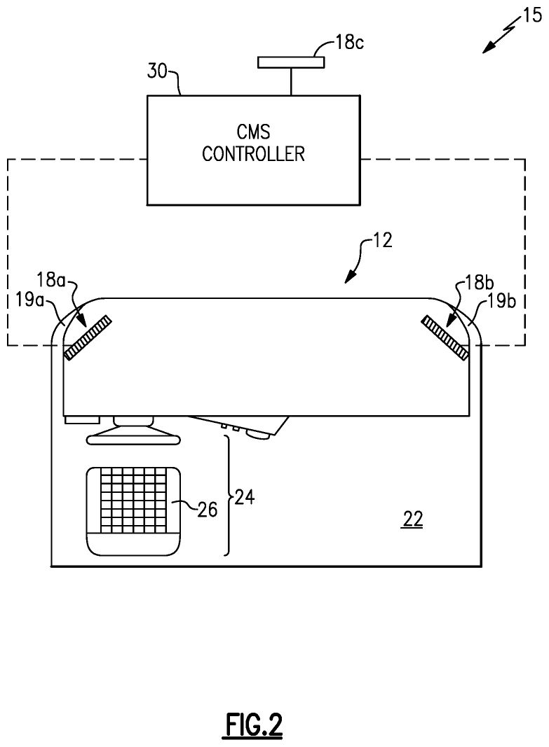

In another example, the reference position determined via the method 300 of FIG. 3 is provided to an image alignment process 900 (illustrated in FIG. 9) and the reference position is utilized to align the images displayed to the vehicle operator on the displays 18a, 18b. Initially, raw images 902, 904 from each side of the vehicle and the corresponding reference positions (determined via the method 300) are provided to the alignment system.

The alignment system generates an initial alignment of the images by aligning the top edge of each image 902, 904 in and “Align Raw Images” step 910. When the cameras are not the same height above the ground, the images appear misaligned and the reference positions of the images are offset by a vertical amount 532. To determine when this is occurring, the process 900 compares the vertical positions of the two reference positions in a compare reference positions step 920.

When the reference positions 530 are offset by a vertical distance 532, the displayed images can look misaligned and can provide a display that is less representative of a real mirror. In order to compensate, and improve the display, the images are cropped and resized such that the reference positions 530 are at the same vertical height 534 in a “Crop and Resize” step 930.

In yet further examples, the alignment method 900 and the height estimation method 700 are operated simultaneously on the same set of images using the same set of reference positions. In other examples, either or both of the methods 700, 900 are operated in conjunction with one or more additional systems utilizing the reference position.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method for determining an image reference position comprising:
receiving at least one image from a camera at a controller, the image including a road lane defined by two identified lane lines and the camera being a component of a camera monitoring system (CMS) for a vehicle;
identifying an inner edge of each of the two identified lane lines using image based analysis;
identifying a vanishing point of the two identified lane lines by extending the identified inner edges of each identified lane line to a point where the extended identified inner edges meet using the controller; and
providing the vanishing point to at least one CMS system as the image reference position.

2. The method of claim 1, wherein the at least one camera is at least one rear facing wing mounted camera.

3. The method of claim 1, wherein the identified inner edge of each identified lane line is an edge facing an inside of lane bounded by the two identified lane lines.

4. The method of claim 1, wherein the CMS system includes a real time camera height determination system, and the real time camera height determination system determines a height of the camera relative to a ground plane by determining an area of a triangle defined by the vanishing point and an edge of each identified lane line, and converting the area of the triangle into a corresponding camera height using the controller.

5. The method of claim 4, wherein converting the area of the triangle into a corresponding camera height using the controller comprises identifying an entry corresponding to the area of the triangle in a lookup table.

6. The method of claim 5, wherein the lookup table comprises a set of ranges of triangle areas, and wherein each range of triangle areas in the set of ranges of triangle areas is correlated with a corresponding camera height.

7. The method of claim 4, wherein converting the area of the triangle into a corresponding camera height using the controller comprises inputting the determined area of the triangle into an equation, and determining the camera height as an output of the equation.

8. The method of claim 1, further comprising comparing the identified vanishing point to a baseline vanishing point and determining that the identified vanishing point is accurate in response to the identified vanishing point being within a threshold distance of the baseline vanishing point.

9. The method of claim 1, further comprising verifying that a precondition is met prior to identifying the vanishing point of the two identifiable lane lines using the controller.

10. The method of claim 9, wherein the precondition is a speed of the vehicle exceeding a first threshold, and yaw of the vehicle falling below a second threshold.

11. The method of claim 10, wherein the first threshold is at least 40 kilometers per hour, and the second threshold is at most 1 degree per second.

12. The method of claim 1, wherein receiving the at least one image from the at least one camera at a controller includes receiving a first image from a first camera and a second image from a second camera, and a first reference point is identified for the first image and a second reference point is identified for the second image; and
wherein the CMS includes a display alignment system configured to align a first display of a first image and a second display of a second image by positioning the reference point of the first image and the reference point of the second image at identical vertical heights of corresponding display screens.

13. The method of claim 12, wherein positioning the reference point of the first image and the reference point of the second image at identical vertical heights of corresponding display screens comprises:
aligning raw images at one of a top edge of the image and a bottom edge of the image;
determining a vertical height difference between the corresponding reference points; and
adjusting at least one of the first and second images such that the vertical height difference between the corresponding reference points is zero.

14. The method of claim 13, wherein adjusting the at least one of the first and second images comprises cropping at least one of the first and second images and resizing at least one of the first and second images.

15. A camera monitoring system (CMS) for a vehicle, the CMS comprising:
a first and second rear facing camera;
a controller including at least a processor and a memory, the memory storing instructions configured to determine a real time camera height of at least one of the first and second rear facing cameras by:
identifying an inner edge of each lane line in two identified lane lines using image based analysis; and
identifying a vanishing point of the two identified lane lines by extending the identified inner edges of each lane line to a point where the extended inner edges meet using the controller; and
providing the vanishing point to at least one CMS system as an image reference position.

16. The CMS of claim 15, wherein the at least one CMS system includes a real time height determination system, and wherein the real time height determination system, determines an area of a triangle defined by the vanishing point and an edge of each identifiable lane line and converts the area of the triangle into a corresponding camera height using the controller.

17. The CMS of claim 16, wherein converting the area of the triangle into a corresponding camera height using the controller comprises identifying an entry corresponding to the area of the triangle in a lookup table.

18. The CMS of claim 17, wherein the lookup table comprises a set of ranges of triangle areas, and wherein each range of triangle areas in the set of ranges of triangle areas is correlated with a corresponding camera height.

19. The CMS of claim 16, wherein converting the area of the triangle into a corresponding camera height using the controller comprises inputting the determined area of the triangle into an equation, and determining the camera height as an output of the equation.

20. The CMS of claim 15, further comprising comparing the identified vanishing point to a baseline vanishing point and determining that the identified vanishing point is accurate in response to the identified vanishing point being within a threshold distance of the baseline vanishing point.

21. The CMS of claim 15, wherein the at least one CMS system includes a display alignment system configured to align a first display of a first image and a second display of a second image by positioning the reference point of the first image and the reference point of the second image at identical vertical heights of corresponding display screens.
